(19) United States
(12) Patent Application Publication
(10) Pub. No.: US 2008/0007774 A1
(43) Pub. Date: Jan. 10, 2008

(54) Macro programming for resources

(76) Inventor: Jane Ruemmele, Indianapolis, IN (US)

Correspondence Address: INDIANO VAUGHAN LLP, SUITE 1300, ONE NORTH PENNSYLVANIA STREET, INDIANAPOLIS, IN, 46204, US

(21) Appl. No.: 11/824,267

(22) Filed: Jun. 29, 2007

Related U.S. Application Data
(60) Provisional application No. 60/818,194, filed on Jun. 30, 2006.

(51) Int. Cl. G06F 3/12

(52) U.S. Cl. 358/1.15

(57) ABSTRACT

A system and a method are disclosed for facilitating a direct-donation from a supplier to a charity. The system receives personally identifying information about a donor at a server computer, and stores the personally identifying information about the donor in a data structure. A client computer communicates to a user one or more items desired by the charity that are available from the supplier. When the user transmits an order to donate the item from the client computer to the server computer, the server computer transmits a printable receipt for the order to donate to the client computer. Additionally, the user is charged for the donation, and the donated item is delivered to or made available for pick-up by the charity.

### REFERENCE TO RELATED APPLICATIONS

This Application claims the benefit of Ruemmele, U.S. Provisional Application No. 60/818,194, filed 30 Jun. 2006.

### TECHNICAL FIELD OF THE INVENTION

The present invention relates to a method for utilizing a distributed computing system. In particular, a system and method are disclosed for creating shortcuts to accessing resources in a distributed computing system.

### BACKGROUND OF THE INVENTION

According to published sources, four years after Sep. 11, 2001 public confidence in charitable organizations remains stuck at a contemporary low. According to a telephone survey of 1,820 randomly-selected Americas interviewed on behalf of NYU Wagner's Organizational Performance Initiative during the Summer of 2005, confidence has held virtually constant since it bottomed out after months of controversy surrounding disbursement of the September 11^{th} relief funds. As of the Summer of 2005, 15 percent of Americans said they had a great deal of confidence in charitable organizations, 49 percent said a fair amount, 24 percent said not too much, and 7 percent said none at all. Public views of how charitable organizations operate also remain unchanged. Only 19 percent of Americans said charitable organizations do a very good job running their programs and services, while just 11 percent said the same about spending money wisely. In addition, 66 percent of Americans said that charitable organizations waste a great deal or fair amount of money, while almost half said the leaders of charitable organizations are paid too much. If the past is prologue, these views will continue to drive higher levels of legislative and media scrutiny, which in turn, may further erode public confidence. The survey also suggests that “rebuilding confidence must involve sustained investment in strengthening the capacity of charitable organizations to achieve measurable impacts toward their missions.”

In order to restore public confidence in charitable giving, and to address the concerns of potential donors as stated above, a new model for charitable giving is needed. In particular, it would be desirable to provide a system and method that would allow a donor to directly donate supplies, materials, and other non-fungible items to a non-profit organization of his or her choice, in order to rebuild and maintain the donor's confidence.

Portions of the disclosed system make use of the Internet. The Internet is a vast computer network consisting of many smaller networks that span the world. A network provides a distributed communicating system of computers that are interconnected by various electronic communication links and computer software protocols. Because of the Internet's distributed and open network architecture, it is possible to transfer data from one computer to any other computer worldwide. In 1991, the World-Wide-Web (WWW or Web) revolutionized the way information is managed and distributed.

Client side browsers, such as Mozilla Firefox, Apple Safari, and/or Microsoft Internet Explorer provide graphical user interface (GUI) based client applications that implement the client side portion of the Hypertext Transfer Protocol (HTTP), which is designed to run primarily over a Transmission Control Protocol/Internet Protocol (TCP/IP) connection. One format for information transfer is to create documents using Hypertext Markup Language (HTML). HTML pages are made up of standard text as well as formatting codes that indicate how the page should be displayed. The client side browser reads these codes in order to display the page.

It would be desirable to provide a system and a method that allows a donor to a charitable organization to easily make in-kind contributions of items that the organization actually needs. It would be further desirable to allow the donor to make these in-kind contributions by either “shopping” in a vendor's store, or via the Internet. It would also be further desirable to allow the charitable organization to easily submit a list of needed materials and supplies to the vendor, so that the vendor may guide the donor in making purchases for the organization.

A system and method are disclosed that allow a non-profit organization to register a project order or other order with a vendor that sells the items it needs. The vendor keeps track of order purchases made by donors either in store, via the Internet, via telephone, or the like. After a purchase is made, the vendor either makes the items available for pick-up by the non-profit organization, or ships the items to a specified location, such as a building site or camp ground. Either at the time of the purchase or at a later date the non-profit organization (or the vendor acting on its behalf) may issue a donation receipt to the donor.

In order to accommodate the budget of various levels of charitable donors, items may be broken down into various monetary amounts. The system and method can be applied to all projects involving materials that could be inventoried: building projects, summer camp programs, scout projects, and the like. Even day-to-day activities could be broken out into inventories and funded through office suppliers. For example, office supplies could be donated through a stationary store, and office equipment could be donated through an electronic store.

There are many benefits to the disclosed system and method. For example, the system allows donors to donate in-kind gifts in a convenient way, and may reduce the fear associated with monetary gifts that the gift could be misdirected or mishandled. The system also may help to create the “measurable impact” that motivates individuals and organizations to donate. Additionally, the system may help the non-profit organization to track its donors for future initiatives. The system may also provide a means for the vendor to keep track of the profits from sales through the system for use in statistical analysis as to the feasibility and success of faith-based and community initiatives as a substitute for government programs. A further advantage of the system is that it may require less governmental oversight than monetary giving, because in-kind giving is straightforward and less vulnerable to misappropriation.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1a is a system architecture of a computer system;

FIG. 1b is a system architecture of a distributed computer system;

FIG. 2 is a memory configuration a computer system;

FIG. 3 depicts a first user GUI (graphical user interface);

FIG. 4 is a flow chart for generating and operating the GUI of FIG. 3;

FIG. 5a depicts a second user GUI;

FIG. 5b depicts a second user GUI featuring the selected item algorithm;

FIG. 6 is a flow chart for generating and operating the GUI of FIG. 5; and

FIG. 7 is an illustrated view of a data structure.

### DETAILED DESCRIPTION

The present invention relates to a method and apparatus for managing computer files containing documents and images of documents. In the following detailed description, numerous specific details are set forth in order to provide a thorough understanding of the present invention. It will be apparent to one skilled in the art however, that these specific details need not be used to practice the present invention. In other instances, well-known structures, interfaces and processes have not been shown in detail in order not to unnecessarily obscure the present invention.

System Hardware

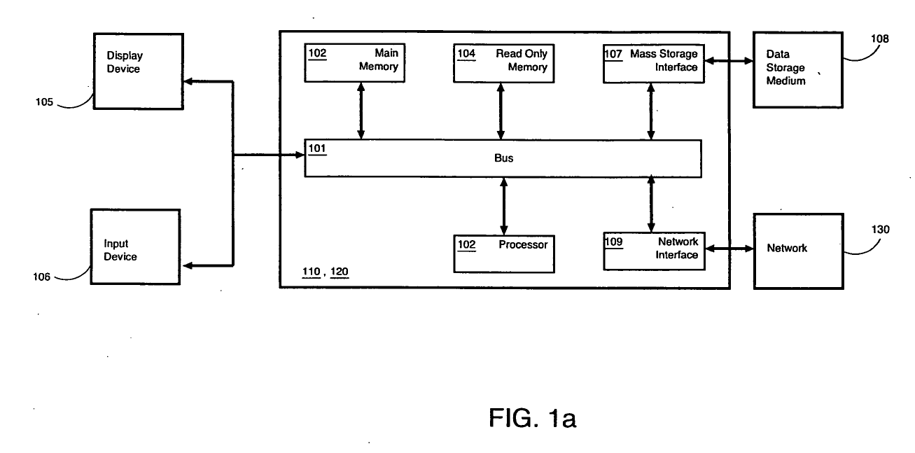

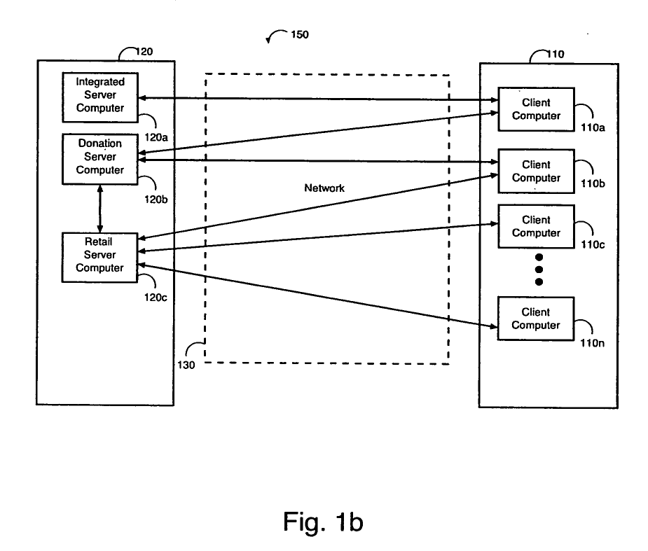

FIG. 1a illustrates an exemplary embodiment of a computer system 110, 120. In this disclosure, one or more client computers 110 communicate with one or more server computers 120. However, as will be appreciated by those skilled in the art, whether a given computer operates as a client or a server depends predominantly on the configuration of the software and/or firmware stored thereon. The preferred embodiment of the present invention is implemented on a personal computer, a workstation computer, a laptop computer, a palmtop computer, or a wireless terminal having computing capabilities (such as a “cell phone” having a Windows CE or Palm operating system). It will be apparent to those skilled in the art that other computer system architectures may also be employed.

In general, computer systems such as those illustrated by FIG. 1 comprise a bus 101 for communicating information, a processor 102 coupled with the bus 101 for processing information, main memory 103 coupled with the bus 101 for storing information and instructions for the processor 102, a read-only memory 104 coupled with the bus 101 for storing static information and instructions for the processor 102, a display device 105 coupled with the bus 101 for displaying information for a computer user, an input device 106 coupled with the bus 101 for communicating information and command selections to the processor 102, a mass storage interface 107 for communicating with a data storage device 108 containing digital information, and a network interface 109 for communicating with a network 130.

The processor 102 may be any of a wide variety of general purpose processors or microprocessors such as the Pentium microprocessor manufactured by Intel Corporation, a Power PC manufactured by IBM Corporation, a SPARC processor manufactured by Sun Corporation, or the like. It will be apparent to those skilled in the art however, that other varieties of processors may also be used in a particular computer system.

The display device 105 may be a liquid crystal device (LCD), cathode ray tube (CRT), plasma monitor, display screen, text-to-speech converter, printer, plotter, fax, television set, or audio player. Although the input device is typically separate from the display device, they may be combined; for example: a display with an integrated touch screen, a display with an integrated keyboard, or a speech-recognition unit combined with a text-to-speech converter, or other suitable display device.

The input device 106 may be any suitable device for the user to give input to client computer system 110, for example: a keyboard, a 10-key pad, a telephone key pad, a light pen or any pen pointing device, a touch screen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye-tracking device, or any MIDI device may also be used as part of the input device 106. Although the input device is typically separate from the display device, they may be combined; for example: a display with an integrated touch screen, a display with an integrated keyboard, or a speech-recognition unit combined with a text-to-speech converter.

The mass storage interface 107 may allow the processor 102 access to the digital information on the data storage device 108 via the bus 101. The mass storage interface 107 may be a universal serial bus (USB) interface, an integrated drive electronics (IDE) interface, a serial advanced technology attachment (SATA), interface or the like, coupled with the bus 101 for transferring information and instructions. The data storage device 108 may be a conventional hard disk drive, a floppy disk drive, a flash device (such as a “jump drive” or SD card), an optical drive such as compact disc (CD) drive, digital versatile disc (DVD) drive, HD DVD drive, Blue-Ray DVD drive, or another magnetic, solid state, or optical data storage device, along with the associated medium (a floppy disk, a CD-ROM, a DVD, etc.).

The network interface 109 may be an IEEE 802.11 network interface card for communicating via Ethernet, a token ring, an AppleTalk, or a wireless local area network such as those described by IEEE 802.11 (a)-(g). The network 130 may comprise a global network, such as the Internet, one or more other wide area networks (WAN), a local area network (LAN), wireless communication networks, a wireless local area network (WLAN), satellite networks, Bluetooth networks, a synchronous optical network (SONET), asynchronous transfer method (ATM) networks, integrated digital subscriber networks (ISDN), frame relay networks, proprietary networks such as provided by American Online, Inc., or other types of communications networks generally known to those skilled in the art. In the embodiment described herein, the network 130 is an Ethernet LAN and the network interface 109 substantially conforms to a wired or wireless variant of IEEE 802.11.

In general, the processor 102 retrieves processing instructions and data from the data storage device 108 using mass storage interface 107 and downloads this information into the random access memory 103 for execution. The processor 102, then executes an instruction stream from the random access memory 103 or the read-only memory 104. Command selections and information input at the input device 106 are used to direct the flow of instructions executed by the processor 102. The results of this processing execution are then displayed on the display device 105.

The preferred embodiment of the present invention is implemented as a software module, which may be executed on a computer system such as the computer systems 110, 120 in a conventional manner. Using well known techniques, the application software of the preferred embodiment is stored on the data storage device 108 and subsequently loaded into and executed within the computer systems 110, 120. Once initiated, the software of the preferred embodiment operates in the manner described below. The processes and operations performed by the computer system 110, 120 include the manipulation of a data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements.

A process may generally be defined as being a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, positioning, placing, illuminating, removing, altering, etc., which are often associated with manual operations performed by a human operator. The operations described herein are machine operations performed in conjunction with various input provided by a human operator or user that interacts with the computer. The machines used for performing the operation of the present invention include local or remote general-purpose digital computers or other similar computing devices.

In addition, it should be understood that the programs, processes, methods, etc., described herein are not related or limited to any particular computer or apparatus nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

Distributed System Configuration

FIG. 1b illustrates an exemplary embodiment of a distributed computer system 150 that may include client computers or any network access apparatus 110 connected to server computers 120 via the network 130. The network 130 may use Internet communications protocols (IP) to allow clients 110 to communicate with servers 120. The network 130 may provide an on-line service, an Internet service provider, a local area network service, a wide area network service, a cable television service, a wireless data service, an intranet, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems, as generally described above. It is noted that the network access apparatus 110 may have a variety of forms, including but not limited to, a general purpose computer, a network computer, an internet television, a set top box, a web-enabled telephone, an internet appliance, a portable wireless device, a game player, a video recorder, and/or an audio component, for example.

Each client 110 and server 120 may be similarly configured as client and server computers, as described generally above. However, in many instances server sites 120 include many computers, perhaps connected by a separate private network. In face, the network 130 may include hundreds of thousands of individual networks of computers. Although the client computers 110 are shown separate from the server computers 120, it is understood that a single computer might perform the client and server roles.

Those skilled in the art will appreciate that the computer environment 150 shown in FIG. 1b is intended to be merely illustrative. The present invention may also be practiced in other computing environments. For example, the present invention may be practiced in multiple processor environments wherein the client computer includes multiple processors. Moreover, the client computer need not include all of the input/output devices as discussed above and may also include additional devices. Those skilled in the are will appreciate that the present invention may also be practiced via Intranets and more generally in distributed environments in which a client computer requests resources from a server computer.

During operation of the distributed system 150, users of the clients 110 may desire to access information records stored by the servers 120 while utilizing, for example, the Web. The clients 110 may execute Web browser programs, such as Netscape Navigator or MSIE to locate the pages or records. The browser programs may enable users to enter addresses of specific Web pages to be retrieved. Typically, the address of a Web page is specified as a URI or more specifically as URL. In addition, when a page has been retrieved, the browser programs may provide access to other pages or records by “clicking” on hyperlinks (or links) to previously retrieved Web pages. Such links may provide an automated way to enter the URL of another page, and to retrieve that page.

In the illustrative embodiment shown in FIG. 1b, retail server computer 120c may be a typical retailers Internet web presence. For example, the retail server computer 120c may be an online ordering site for a hardware store, for an office supply store, for a general merchandise store, for a department store, or the like. In this illustrative example, the retail server computer 120c contains only minor modifications to implement the system and method disclosed herein.

The donation server computer 120d may be a server computer system that is operated by a charitable, or a non-profit organization for the purpose of receiving direct in-kind contributions. For example, a charitable organization, such as Habitat for Humanity, may maintain such a server computer 120d as a means for entering and tracking project information. The charitable organization may have a project that entails constructing a new home for a homeless person. In this case, the charitable organization may create a project title “House A” that includes a list of all building materials required to build the subject house. The records for this project may be accessed by the retail server computer 120c, such that an individual desiring to make an in-kind contribution to the charitable organization can log into the retail server computer 120c, see the materials required for the project, and order the building materials as a donation for the charity.

Additionally, the integrated server computer 120a may include all data structures and user interfaces required to fully implement both the retail server computer 120c functionality as well as the donation server computer 120d functionality. The integrated server computer 120a may be better suited for smaller charitable organizations, such as churches, that would like to receive in-kind contributions of materials and supplies, but that do not employ the necessary information technology resources to maintain the donation server 120b. The integrated server computer 120a may be maintained by an individual retail organization, such as those listed above, or may be maintained by an umbrella organization that serves multiple charities, such as a local council of churches.

Generally, during operation, a user will access a client computer 110, such as client computer 110a, and visit a website hosted by, for example, the server computer 120a or the donation server computer 120b. Additionally, a user may access a computer such as the client computer 110c, and access the retail server computer 120c. In either case, as explained in greater detail below, the user may be able to purchase materials for an in-kind contribution to the respective charitable organization, without leaving the users home.

Additionally, as will be understood by those skilled in the art, the client computers 110 may be contained in one or more kiosks that are located within a retail store. For example, a department store or an office supply store may have a kiosk dedicated to direct charitable contributions, and that kiosk may contain a client computer 110, such that a user can make a donation while visiting the store. Additionally, for such kiosk embodiment, the system may provide for the ability to print a “shopping list” so that the user can examine the items requested by the charity in the store, and select the items that the user wishes to order based upon a personal inspection. The use of such a shopping list-type order sheet is known to those skilled in the art.

Software and Data Components

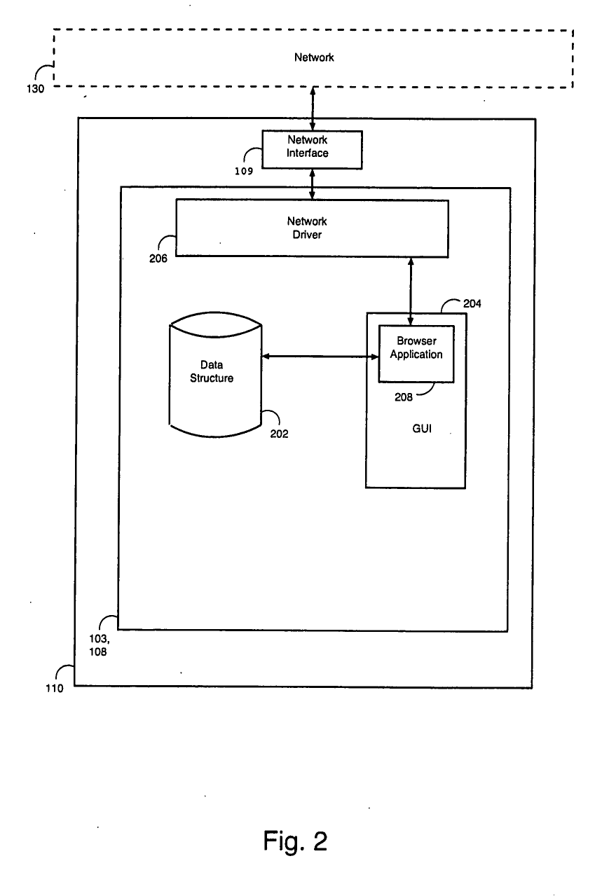

Turning to FIG. 2, illustrative software and data components stored by the data storage medium 108 and the main memory 103 are shown. The components may include a data structure 202, a graphical user interface (GUI) 204, and a network driver 206. The GUI 204 may have an associated GUI data structure or database (not shown) that stores the contents of each of the button and frames or fields. The entire contents of the GUI data structure can also be updated when events occur at a server 120, such as when the user navigates to a new web site.

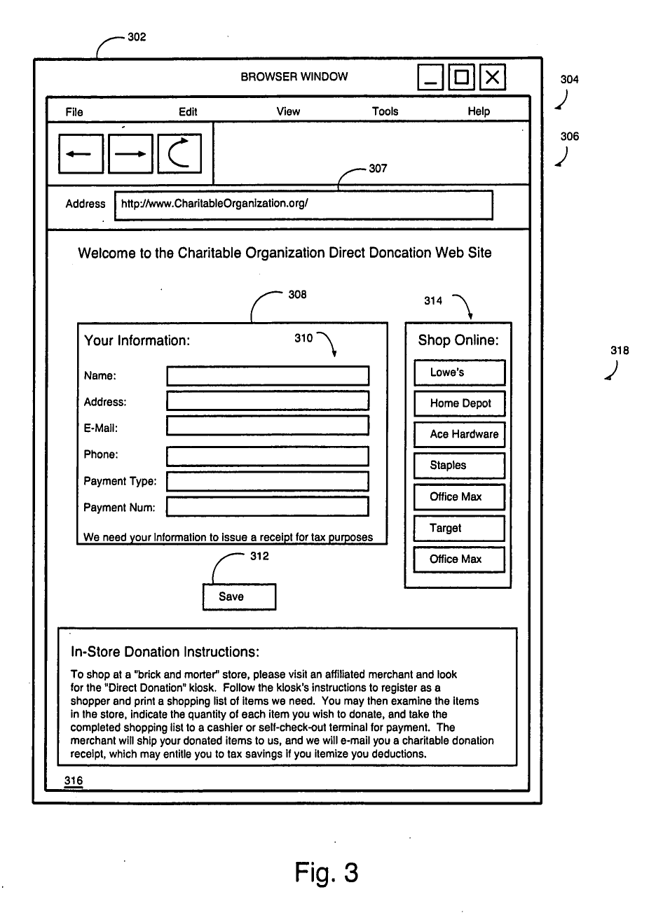

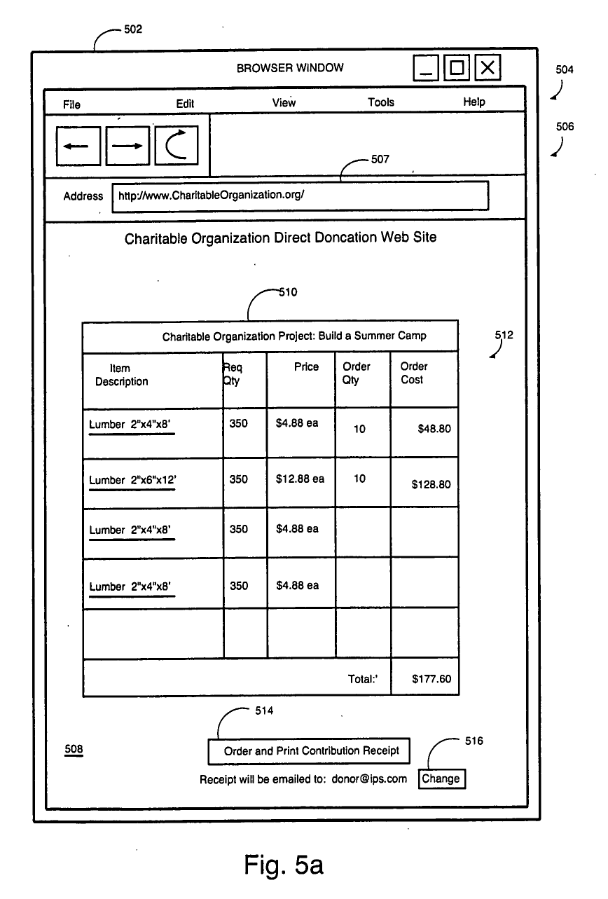

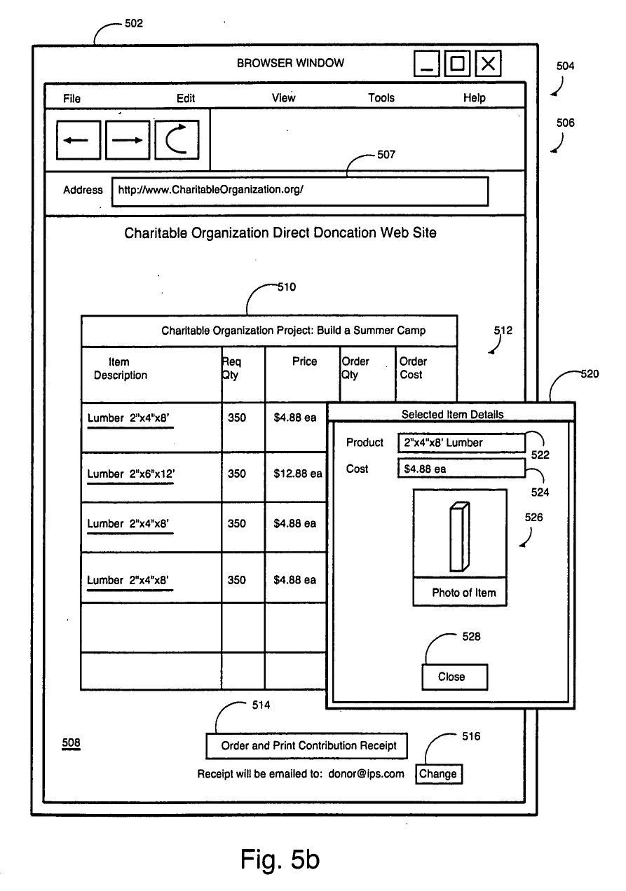

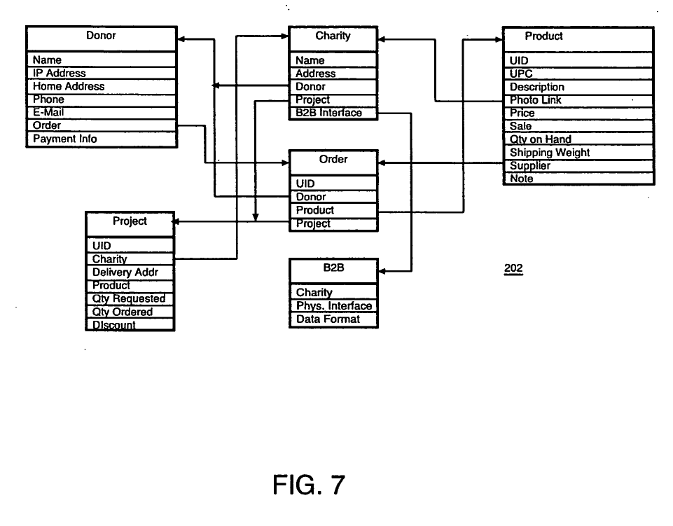

The GUI 204 may include a browser application 208. For example, the browser application 208 may be any of the commercial browser applications described above, or a custom web browser application. The browser application 208 may generate a browser window 302, shown in FIGS. 3 and 5. The data structure 202 may store information regarding the macros. Although the data structure is shown as being stored in main memory 103 and/or data storage medium 108 of the client computer 110, in one embodiment the data structure 202 is stored in a memory of the server 120. In another embodiment, the data structure 202 is stored in the memories of both the client computer 110 and the server computer 120. Such an embodiment of the data structure 202 is illustratively shown in FIG. 7.

The browser application 208 may communicate with server applications on server computer 120 via a network driver 206. For example, the network driver 206 may implement the TCP/IP internet protocol, as well as Ethernet and/or other lower-layer protocols. The browser application 208 may also communicate simultaneously with, for example, a first server 120a and a second server 120c via the network driver 206.

Donor Information Graphical User Interface

As shown in FIG. 3, the browser application 208 generates a browser window 302 within the GUI 304. The browser window 302 may include a menu bar 304, as would be familiar to one accustomed to using an Internet web browser application. Additionally, the browser window 302 may include a toolbar 306, an address frame 307, and a display area 316, also familiar to persons using Internet browsers. The toolbar 304 may include the top-level widgets for a file menu, an edit menu, a view menu, and the like. Those familiar with using windowing operating systems will be familiar with the use of such a menu bar. The toolbar 306 may include widgets that allow the user to move back to a previous web page, forward to a next web page, to reload the current web page, and the like. The address frame 307 may provide a location for the entry of a URL address for a website to which the user wishes to navigate. The display area 316 may render the contents of the HTML or other source code contained at the address specified by the URL in the address frame 307.

FIG. 3 shows an illustrative search site rendered in the display area 316. The website includes a form 308 that allows the user to enter personal information in a series of text boxes 310. Additionally, the website includes a save button 312 and shop online buttons 314. Once the user has entered user's personal information, such as, for example, name, address, e-mail address, phone number, payment type, and payment number, the user may choose to either save this information in a database by selecting the button 312, or shop online by selecting one of the buttons 314. The operation of the website is explained in further detail below.

Additionally, the website may include instructions for the user to make an in-store donation. This may be beneficial to the merchant operating the website, because by having the user visit a physical store, the user may be inspired to make additional purchases for his or herself.

Donor Information Algorithm

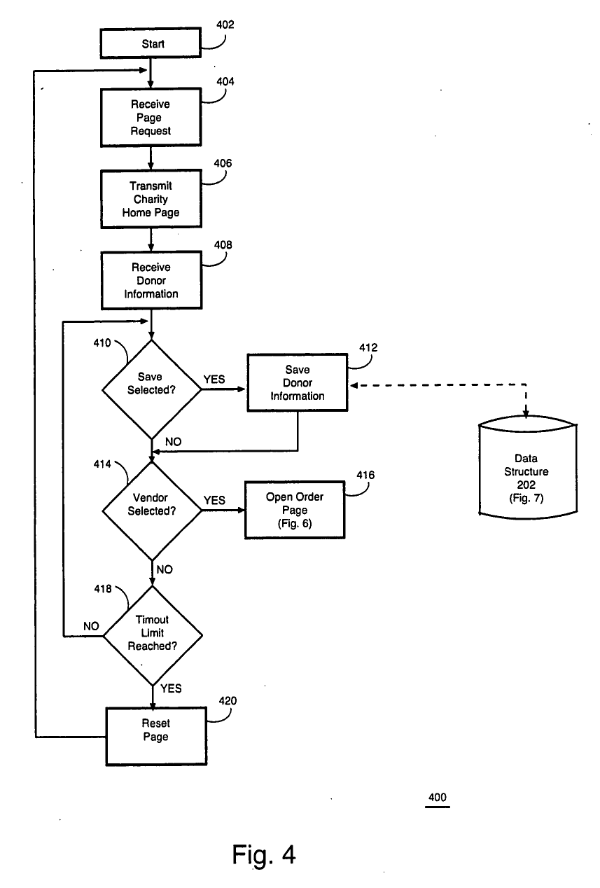

Turning to FIG. 4, a flowchart for an illustrative algorithm to capture and store a donor's personal information is shown. The processor 102 enters the algorithm at 402. At 404 the processor receives a request for the homepage of the charitable organization. At 406, the processor 102 transmits the charity homepage to the client computer 110 making the request. At 408, the processor 102 receives the personal information of the donor. At 410, the processor 102 determines whether the user has selected the save button 312. If so, then the algorithm stores the profile of the user during step 412. The processor saves the donor information in the data structure 202.

If the user did not select the save button 312, then at 414 the processor 102 determines whether the user has selected one of the vendor shop online buttons 314. If so, then at 416, the processor transmits to the client computer 110d an appropriate order page from the selected vendor's site. If the user has not selected either the save button 312 or one of the shop online buttons 314, then at 418 the processor determines whether a time out limit has been reached. If so, then at 420 the processor at 102 resets the page. If not, then the processor 102 returns to step 410 to see if the user had decided to save his or her personal information or shop online.

Donation Placing Graphical User Interface

FIG. 5a shows that an illustrative charitable organization direct donation website. As shown in FIG. 5a, the browser application 208 may further generate a browser window 502 within a GUI 504. The browser window 502 may include a menu bar 504, as would be familiar to one accustomed to using an Internet web browser application. Additionally, the browser window 502 may include a toolbar 506, an address frame 507, and a display area 508, also familiar to persons using Internet browsers. The toolbar 504 may include the top-level widgets for a file menu, an edit menu, a view menu, and the like. The toolbar 506 may include widgets that allow the user to move back to a previous web page, forward to a next web page, to reload the current web page, and the like. The address frame 507 may provide a location for the entry of a URL address for a website to which the user wishes to navigate. The display area 508 may render the contents of the HTML or other source code contained at the address specified by the URL in the address frame 507.

FIG. 5b shows an illustrative donation-placing webpage rendered in the display area 508. The donation-placing page may include a table 512 that includes columns for item descriptions, requested quantities, prices, and the like. For example, each row of the table 512 may represent an item that is needed by the charitable organization in order to complete a project. In this illustrative example, the charitable organization is requesting various types of lumber, such as 2″×4″×8′ pieces of framing lumber for the current project. The price for each piece of this framing lumber if $4.88. In the example, the user has indicated a willingness to order 10 pieces of this framing lumber for the charity, for a total cost of $48.80. Similarly, the user has indicated a willingness to buy additional lumber, as shown in FIG. 5a. The table 512 also includes a project description box 510. This project description box 510 may indicate the name of the project for which the donated material is requested. In this case, the name of the project is “Build a Summer Camp.” The table 512 may also keep a running total of the donated materials cost, as shown.

It is possible that the donor may not know enough about a requested item from the item description in the table 512 to make an informed decision regarding a donation. Therefore, in one illustrative embodiment, the item description may be a hyperlink that, when clicked, provides further information about the item. For example, as shown in FIG. 5b, a pop-up window 520 of item details for a selected item may be presented to the donor upon selection of the hyperlink for an item. This pop-up window 520 may include a product description box 522, a cost box 524, and a photo frame 526. The photo frame 526 may include a photograph of the item. Additionally, the pop-up window 520 may include a close button 528 that allows the user to close the pop-up window 520 and return to the main donation-placing page.

Returning to FIG. 5a, the display area 508 may further include an order and print button 514. When the user selects the order and print button 514, the system may place the order, and print a contribution receipt for the user to submit with his or her tax return. Additionally, the display area 508 may indicate an e-mail address to which the receipt may be sent in a printable format, such as portable document format (PDF). In this case, a change button 516 may be included to allow the user to change the e-mail address to which the contribution receipt will be mailed. In other embodiments, the receipt may be downloaded to the client computer 110, or printed via a printer coupled to the client computer 110.

Donation Placing Algorithm

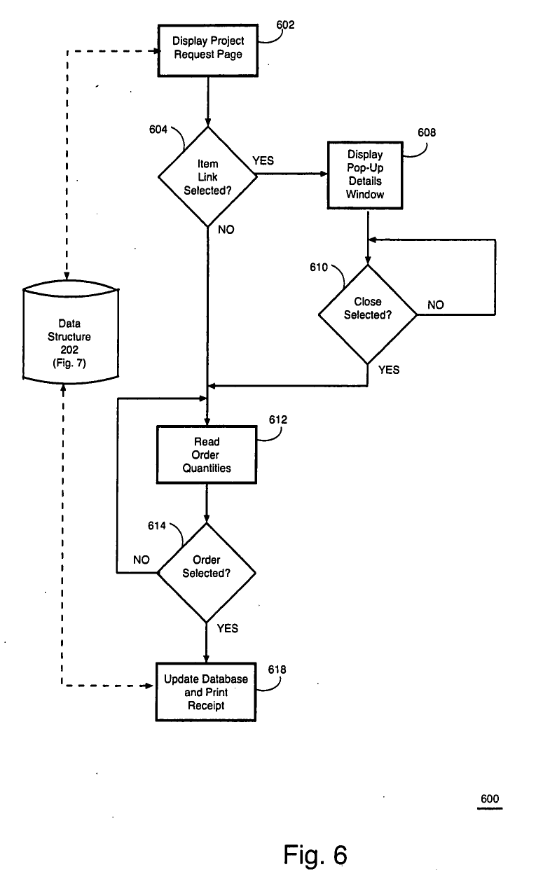

Turning to FIG. 6, a flowchart for an illustrative algorithm to place a donation order is shown. The processor 102 enters the algorithm at 602. At 602, the processor 102 reads the project data from the data structure 202 (shown in FIG. 7) and displays the project request page shown in FIG. 5a-5b. At 604, the processor 102 determines whether the user has selected the close button 528. If not, then the processor waits at 610. If the user has selected the close button 528, then the processor continues to 612.

If the user has not selected an item at 604, then at 612, the processor reads order quantities from the table 512. At 614, the processor 102 determines whether the use has selected the order and print button 514. If not, then the processor 102 returns to 612 to read further order quantities. However, if the order and print button 514 is selected, then the processor continues to 618. At 618, the processor updates the database 202, and prints, e-mails, downloads, or otherwise communicates a receipt to the client computer 110.

At 602, the processor 102 reads the project data from the data structure 202 (shown in FIG. 7) and displays the project request page shown in FIG. 5a-5b.

Data Structure Associations

Turning to FIG. 7, an illustrative data structure for storing information regarding donations, charity data, user data, and the like is shown. The data structure 202 may be stored on a server computer 120. The data structure 202 may include a donor table, a charity table, a product table, an order table, a project table, and, optionally a business to business (B2B) table. The donor table may include information for each donor, such as his or her name, user ID, IP address, home address, and the like. The charity table may include information for a charity, such as its name, address, associated donors, and the like.

Additionally, in the case of an embodiment where a donation server 120b communicates with a retail server 120c, the charity may include a B2B interface entry. The B2B table may include information for the charity, such as its physical network interface, and the data format interface for its business-to-business communication from the donation server 120b to the retail server 120c, as is known in the art.

The project table may include a unique identification number, the associated charity, the delivery address for the charitable donations for the project, products requested for the project, and the like. The product table may include a unique ID for each product (such as a retailer-specific SKU number), a UPC code for each product, a description of each product, and the like. The use of a product table by a retail organization to track products is known in the art.

Regarding the entry of charitable projects into the database, a retail organization may configure, for example, the integrated server computer 120a to include a “shopping cart” as is known in the art. However, because each charity may have multiple projects, the integrated server computer 120a may maintain a plurality of such “shopping carts” for each charity so that a charity may order different items for different projects at different times.

In another embodiment, the retail server computer 120c may be configured to receive electronic data orders from a donation server computer 120b. In this embodiment, the charitable organization may place orders with the retail organization in the same manner that a manufacturing facility would place electronic orders with its parts suppliers. The configuration of business-2-business communication systems for the purpose of ordering parts and supplies is known in the art.

The many features and advantages of the claimed invention are apparent from the detailed specification and, thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention.

What is claimed is:

1. A method of facilitating a direct-donation from a supplier to a charity for use with a computer, comprising:
receiving personally identifying information about a donor at a server computer via a client computer;
storing the personally identifying information about the donor in a data structure;
communicating, via the client computer, an item desired by the charity that is available from the supplier;
receiving, at the server computer, an order to donate the item from the client computer; and
transmitting a printable receipt for the order to donate from the server computer to the client computer.
